(19) United States
(12) Patent Application Publication
(10) Pub. No.: US 2017/0278080 A1
(43) Pub. Date: Sep. 28, 2017

(54) Payment By Image

(71) Applicants: Kenneth Kruszka, San Francisco, CA (US); Joanna Lipinski, San Francisco, CA (US)

(72) Inventors: Kenneth Kruszka, San Francisco, CA (US); Joanna Lipinski, San Francisco, CA (US)

(21) Appl. No.: 15/077,938

(22) Filed: Mar. 23, 2016

(51) Int. Cl. G06Q 20/04; G06K 9/00; G06Q 20/06; G06Q 20/38; G06Q 20/40

(52) U.S. Cl. CPC G06Q 20/042; G06Q 20/3829; G06Q 20/405; G06Q 20/4037; G06Q 20/065; G06K 9/00442; G06Q 2220/00

(57) ABSTRACT

Processes and methods for simple and streamlined creation, transmission, and acceptance of payment in the form of a digital image, transformable to interoperate with various modes of legacy processing and settlement. Methods are illustrated to speed clearing and provide guarantee of funds availability. Enhancements are described that provide flexibility in the application and use of payment images that are not possible with other payment mechanisms. And, a system is proposed to implement these processes and methods.

### BACKGROUND

The use of imagery and pictures to convey information dates back over 40,000 years to the earliest cave paintings. The need to transact and conduct commerce has been a necessity since these earliest times as well. Yet, these two mechanisms have never been paired.

As far back as 128,000 BC, humans have exchanged resources through barter. The advent of tangible money dates back to the use of Cowry Shells as early as 1,300 BC. The Chinese Western Zhou Dynasty introduced the concept of metal coins as a form of currency in 1,000 BC, and the western world followed suit in 687 BC in what is now modern-day Turkey.

The genesis of the check as a form of payment dates back to 300 BC in ancient India when a document called Adesha was presented to a banker from a third party. Checks are the second oldest form of payment behind cash, and came into prominence in the 1600s. Meanwhile, bank notes have their origin in 806 AD in China, brought about by the shortage of copper to mint coins. And in 1661, Sweden was the first western country to issue banknotes.

The 1800s, 1900s, and 2000s have brought on the advent of electronic money with electronic funds transfers, credit and debit cards, and now digital currencies such as Bitcoin.

Through all these innovations, the image has never been used as a form of payment. To be sure, banknotes and checks do have imagery printed on them. However, those images are static and do not contain usable payment information for effecting a transaction.

The inventions described herein present a new form of payment artifact, a payment image, which encapsulates all the necessary payment information within it in order to conduct a financial transaction, and which can be transferred electronically or physically from payer to payee.

### SUMMARY

This document generally describes processes, methods, and systems that allow for a simple, easy, efficient, and quick way for a person to make a payment or move money to another person or entity, through a novel mechanism built around images and image processing.

At their root, the processes here allow a party (whether it be an individual person, a business entity, or event an autonomous computer agent) to use a simple application on their computer, mobile phone, or other device to enter some minimal authentication information, to quickly search and find another party, and to in a few short steps generate a digital image that is automatically sent to the payee electronically. That image either encapsulates all the information necessary to effect payment, or represents a token to such payment information stored and retrievable from an external data store. This digital image is referred to as a “payment image”.

The invention describes processes not only for the creation of a digital image by the payer, but also for the acceptance and processing of the digital image by the payee, along with sample reference implementations for each party in the ecosystem.

There are further inventions described here that enhance the security of the payment image, demonstrate different applications and uses of the payment image, and new efficiencies for the payee for the processing, clearing, and settlement of the payment image by the payee's depository financial institution, or similar third party intermediary.

In one realization of the invention, the payment image is presented in a form and formation that is consumable, useful, and usable with the various legacy processing and settlement infrastructures already in use in the financial industry. While, in other realizations of the invention, the payment image requires additional manipulation to convert it into a form and format that is consumable and usable by legacy systems. And, in yet other realizations, the processing of the payment image is done in wholly new mechanisms outside of the legacy infrastructure.

A key aspect is in the streamlining of the generation and transmission of the payment image from a payer to a payee such that the form and format of that payment can be made useful and useable within legacy payment acceptance and settlement infrastructures. In its simplest form the digital image is an electronic artifact that can be readily viewed, printed onto paper in a way to produce tangible payment instructions, or used in its digital form directly by systems such as ATM, POS systems, or mobile banking applications with remote deposit capture functionality.

Built on top of and supporting the creation of payment images are inventions for the archival and rapid retrieval of information to populate the payment information represented by the payment image. This includes information about the payer such as name, address, financial institution, account and routing numbers, e-signature, etc. Further, the archival and rapid retrieval of information relevant to the payee, such as name and preferred delivery method and location, can cut down on data entry errors, erroneous delivery, and the risk of the payment image being rejected during clearing and settlement. These key, relatively static data elements are common to many payment mechanisms, and their archival in a Repository streamlines the entire payment image creation process.

One realization of the payment image is in the generation of a digital check image, which is created on the payer side of the transaction and sent electronically to the payee. On the acceptance side, Check21 Act has standardized and streamlined the processing, clearing, and settlement of checks, mostly through the mandate of a “substitute check” that can be archived and transmitted between financial institutions instead of shipping and reconciling paper checks. However, because the generation of a substitute check traditionally relies on image processing to filter out the noise in the picture taken of a physical paper check, there is the possibility of rejection due to poor image quality. In order to address that shortcoming, the digital check described here will be free from defects common to paper, such as poor lighting and wrinkles. A picture of the digital check (i.e. the payment image) will be readily available on a visual screen or directly as an image format, and since it was generated automatically, the image processing rejection rate will be near-zero.

Furthermore, if processed by the described Acceptance Engine instead of a traditional image processing package, the Check21 substitute check can be extracted directly, in a pure and pristine form from the payment image on the payee side of the transaction. This can be done because the substitute check can be embedded as meta-data or a watermark within the payment image. So, instead of using traditional image processing techniques for noise reduction and optical character recognition, the pure substitute check can be produced by a simple watermark extraction method from the payment image.

The invention expands upon the use of watermarks and other meta-data to provide even greater capabilities on the payment image, including better fraud protection, enhanced traceability, escrow capabilities, encryption, etc. With a data format and functionality that can be implemented either as standalone components (such as the Acceptance Engine) or that can be wrapped together into a self-executing payment image executable, the implementation can be either highly centralized or highly distributed, allowing for tremendous resiliency in the system as a whole.

Beyond providing a functionality to simply produce a new form of payment that interoperates with the existing infrastructure, the invention goes on to describe additional systems and processes for ridding the settlement ecosystem of some of its deficiencies. A very common problem for some forms of payment is that there is no guarantee of good funds at the time that the payment is made. Described below is a method for segregating good funds into a holding account, at the time that the payment is created, and reserving those funds until the payment is redeemed or rescinded. This hold on funds provides a guarantee against a rejected payment for insufficient funds, because the payment image would not even be created if there are insufficient funds in the account of the payer.

Another enhancement to the system and processes provides a mechanism for flexibility of the payment image. Unlike the static nature of certain forms of payment, such as a paper check, where the payee information is determined at the time the check is written, a payment image can be dynamic. It is possible to reassign a payment image to a new beneficiary or to an anonymous beneficiary because the format of a payment image is malleable. This allows the payment image to be used over and over for commerce, and reassigned, without the need to redeem it and issue a new one. This creates efficiencies and reduces fees for merchants, their vendors, suppliers, and consumers alike. And, this invention allows for a payment image to be used as a bearer instrument, payable to the holder, not necessarily to a particular named beneficiary.

The transferability of payment images is further enhanced through a process to associate the payment image with new and emerging protocols and cryptocurrencies. By attaching a payment image a bitcoin transaction, for instance, it is possible to enhance not only the delivery of a payment image, but also its accountability and ownership. This is particularly interesting when done in conjunction with the payment image being used as a transferrable bearer instrument because it provides a method of nonrepudiation and a clear trail of ownership in the bitcoin general ledger.

One important shortcoming of some payment methods is that they are not usable in a digital, ecommerce scenario. However, the realization of the payment image does not have such limitations. Due to the electronic format, the payment image can be easily created and applied as payment within an ecommerce website, for instance. This flexibility allows for the payment image to be used in physical retail stores, as well as in scenarios that lend themselves better to electronic payment methods.

The details of one or more embodiments of the invention are set forth in the accompanying drawings and descriptions below. Other features, objects, advantages, and implementations of the invention will be apparent from the description, the diagrams, and the claims.

### DESCRIPTION OF DRAWINGS

FIG. 1 shows a basic processing flow from initiation of a payment image, the population of necessary payment information, the delivery of the payment image to the payee, the conversion of the payment image into a digital check, and the submission of the digital check to payee's financial institution

FIG. 2a shows a basic process for creating a Check21 “substitute check” from payment information gathered from payer and payee, and utilizing that substitute check as the payment image

FIG. 2b shows a basic process for creating a watermark in the format of a Check21 “substitute check” and overlaying that watermark on top of a nondescript picture to create the payment image

FIG. 3a shows a basic process for payment image acceptance, verification, and submission of derivative substitute check to depository financial institution

FIG. 3b shows an extended process for payment image acceptance, verification, clearing, and settlement involving both the issuing financial institution and the depository financial institution

FIG. 4 shows a simple process for utilizing the payment image for escrow transactions through the obfuscation of important payment information on the image and a process for clearing those conditions

FIG. 5 shows a process for verifying good funds prior to payment image creation, and for holding those funds to ensure clearing and settlement

FIG. 6 shows one potential process for allowing a banking application or site to bypass the camera and directly upload and process a digital check payment image

FIG. 7 shows a simple process for utilizing public key / private key or other authentication mechanisms to secure the payment image

FIG. 8a shows the use of social network or online banking credentials and accounts in order to populate the Repository, which will be used to streamline creation of payment images

FIG. 8b shows the use of visual processing software to extract payment account information from documents such as bank statements or paper checks in order to populate the Repository

FIG. 9 shows the process for reassigning a payment image from one payee to another

FIG. 10 shows the process for reassigning a payment image from a named payee to an anonymous payee

FIG. 11 shows the basic process for customers to pay merchants using a payment image

FIG. 12 shows the process for associating a payment image with a new financial settlement protocol, such as Bitcoin

FIG. 13 shows implementation components of a system to realize the processes described herein

### DETAILED DESCRIPTION

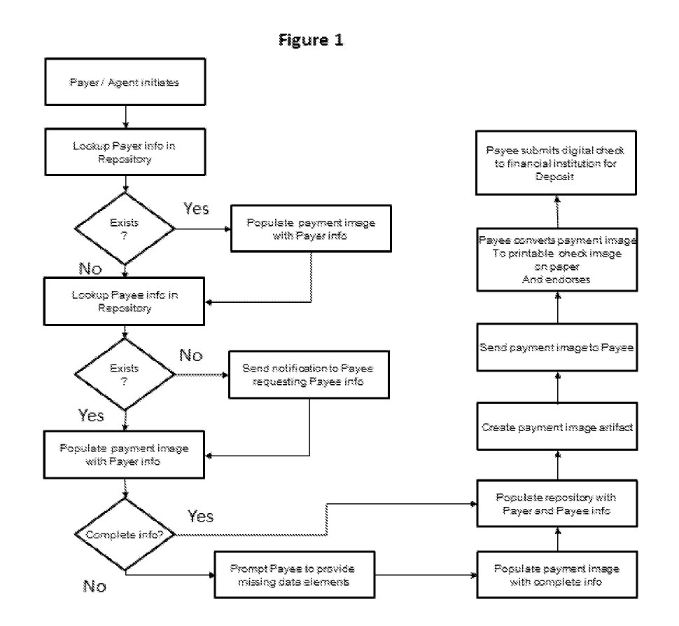

FIG. 1 shows the basic process for the creation, transmission, and clearing of a payment image. In this scenario, a Payer who would otherwise pull out a checkbook and write a physical check and hand or mail that check to a Payee or use an electronic funds transfer technology like ACH, SWIFT, or Paypal, instead utilizes an electronic device or software interface to initiate a payment image. The interface gathers all the necessary payment account detail information from the Payer (such as name, address, financial institution, account number, routing number) in order to populate the data that will be encapsulated in the payment image.

In the creation of the payment image, the visual layout of this payment information may or may not adhere to standard and acceptable formats. For instance, the layout of the payment information may resemble that of a paper check, including placement of data elements and the use of MICR fonts for routing, account, and check number information. (In one realization of the payment image, the format of checks is leveraged heavily in order to more seamless interoperate with legacy financial systems and processes.)

In addition, the Payer optionally also provides a digital image of his signature through generally available signature capture technologies.

All this payment information and signature information is archived in a repository, so that the Payer need not reenter boilerplate information again and again when issuing additional payment images at a later time.

The Payer also provides information specific to this single payment, such as an identifier associated with the payee and the amount of the payment. Based on unique and verified identifying information, the system prepopulates the Payee information if the Payee has previously registered himself or if such information is available in publicly accessible databases. The unique identifier could be government ID, Social Security Number, email address, mobile phone number, Social Network login, or any other unique identifier.

From this Payee identifier, the system can retrieve the Payee's payment information (such as full name, account numbers, etc.), which is necessary for the payment itself, as well as other information and preferences that the Payee might have, such as the preferred method of delivery, which could be email, secure email, file transfer, drop box, or even physical check to his home address, or any other electronic or physical delivery method.

With the preferred delivery method, the system automates the sending of the completed payment image to the Payee, or will even facilitate the direct deposit of the payment directly into the Payee's bank account, if that preference is selected.

The initiation could be done by the Payer through any device, such as a mobile phone or computer, or through a representative automated agent, such as a smart device that is given authorization to act on behalf of the Payer but operates partially or fully autonomously. The software interface implemented could be either completely stand-alone, or embedded into other platforms and interfaces.

The Payee, once the payment image is received, has the option of utilizing the digital artifact, that is the image or file, directly in its digital form, or to generate a digital check representation that can then be used electronically or printed onto paper. The digital artifact may be more useful for depositing electronically through a banking website or for automating through a batch process to process a high volume of checks efficiently. The paper version may be more useful for deposit at an ATM, bank branch, or check cashing store. And, for remote deposit capture through a mobile banking app, either could be used as the camera on the phone could take a picture of a computer screen with the digital check image on it just as well as it would take a picture of a physical check. Or the mobile phone's camera could be bypassed altogether and the payment image or associated digital check could be uploaded directly into the mobile banking app through a software plugin or software development kit (SDK) functionality.

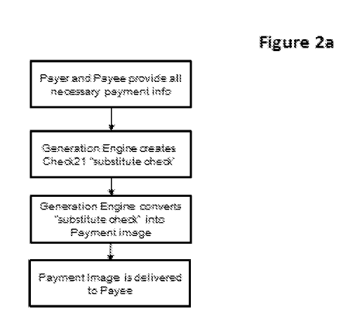

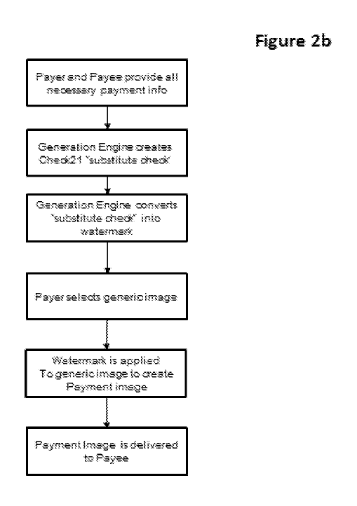

FIG. 2a and FIG. 2b show processes for embedding and overlaying a “substitute check” conforming image, in the sense defined by the Check21 Act or similar computer processable format, as a component within the payment image. The substitute check is a standard image representation that allows for paper checks to be cleared electronically through the Fed check clearing system and allows for financial institutions to destroy the original paper check.

In the case of issuing a payment image, there is no paper check to scan, but the payment image itself either directly conforms to the substitute check format or, if the Payer prefers a nicer aesthetic payment image, the substitute check format is overlayed onto a selected generic picture as a watermark that is either fully readable or optionally nearly imperceptible to the human eye.

With such a watermark in place, a complementary system extracts the watermark from the payment image and reconstructs a full substitute check. That substitute check representation is then submitted directly to the Fed clearing system via the depository financial institution. Such a process allows for the acceptance of payment images even without the need for traditional remote deposit capture image processing software, which dissects a standard check image, identifies the relevant pieces of data (name, account number, amount, etc.) based on their location on the check and even the font or format of the data element (such as the use of MICR code), and from that information, constructs the substitute check.

Instead, in this process, a simple watermark is extracted from the payment image, and that watermark is already in the substitute check format, or, in the simplest case, the payment image itself is already in the substitute check format.

Additionally, optional processing can verify meta-data and the watermark embedded in the payment image against data stored in the Repository at creation time. This extra verification step provides a safeguard against fraudulent creation or tampering with a payment image, and is something not possible today with standard paper checks.

The watermark is not limited to containing only the substitute check, however. Other security, uniqueness, or relevant information can also be encoded into the watermark in order to provide greater functionality, usability, or security to the users of payment images.

The explicit format of the watermark or the payment image is not relevant. It may take on any form from QR codes to abstract imagery or to the actual image representative of information encoded.

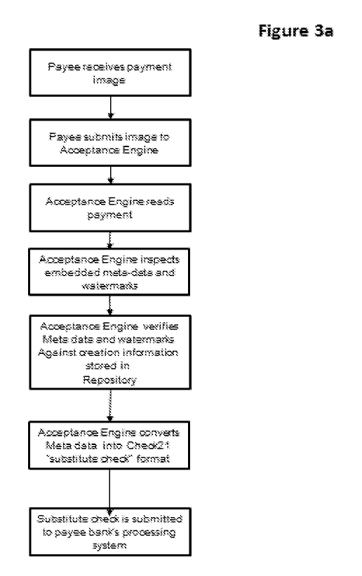

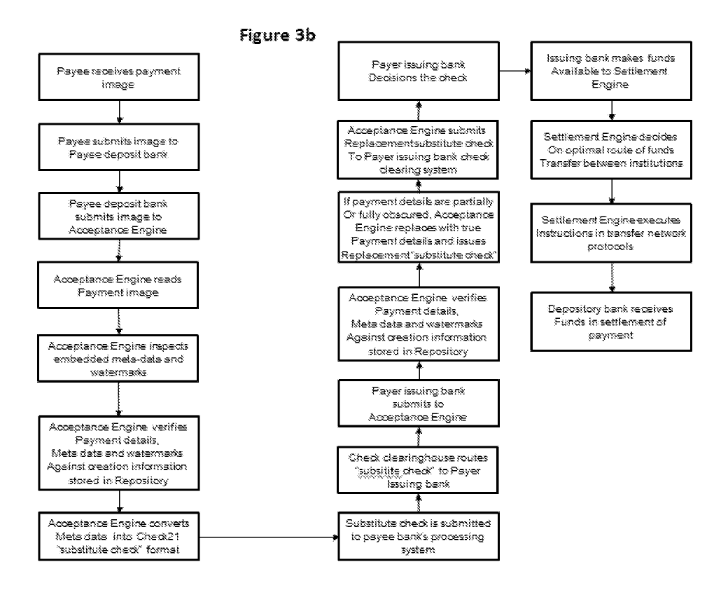

FIG. 3a shows a process for extracting and leveraging the meta-data encoded in the payment image. In this example scenario, the meta-data is being extracted by an Acceptance Engine which inspects the data repository and once the meta-data is verified and all safeguards and tests are passed successfully, then a substitute check is generated for submission to the Fed check clearing system via the systems of the depository bank.

The use of extra meta-data is an optional extra layer of security and fraud protection that is unique because payment images are being created “on the fly” instead of having paper stock that is pre-printed before the check details are fully known. In this way, not only can the payment image contain information relevant to the Payer and Payer's account, but it can also contain information relevant to the amount of the transaction, the date of the transaction, or the Payee. Such meta-data would virtually eliminate the possibility of “washing”, and is a distinct advantage over traditional paper checks.

Further, the meta-data could incorporate uniqueness information, such as a global check identifier number. Through the acceptance process, the digital check can be precisely matched back to its creation and whether it was cashed or not, thereby all but eliminating the risk of “double cashing”, which is another advantage over checks and other transferrable payments instruments.

For the removal of doubt, the Acceptance Engine may be incorporated into a central server or may be implemented as a component within an application used, in isolation, by the Payee or Payee's financial institution for the purposes of payment image acceptance, clearing, and settlement. Similarly, the extra steps to verify payment information extracted from the payment image against that information stored in an external data store is an extension, but not a necessary component of the Acceptance Engine and its process.

FIG. 3b further extends the process of FIG. 3a to show the clearing of the payment between the two stakeholder financial institutions. In this scenario, it is assumed that the created payment image contains payment details that are either partially or wholly obscured. When the Payee deposits the payment image at the depository bank, the depository bank payment acceptance system can submit the payment image to the Acceptance Engine to receive a partially obscured payment instrument. This partially obscured instrument will have all the information necessary for routing the payment information back to the originating, issuing financial institution. Once received by the issuing institution, the artifact will be submitted to the Acceptance Engine for further manipulation in order to provide the true payment details in the clear, without any obfuscation. This will allow the issuing institution to decision the payment request according to its own business rules.

Once approved, the Settlement Engine decides the optimal path to affect the flow of funds from issuing institution to depository institution. This path may involve tradition mechanisms, such as the check clearing networks, ACH, credit/debit payment networks, etc. and may also involve cryptocurrency networks such as Bitcoin/Blockchain, as an example, or a combination of networks.

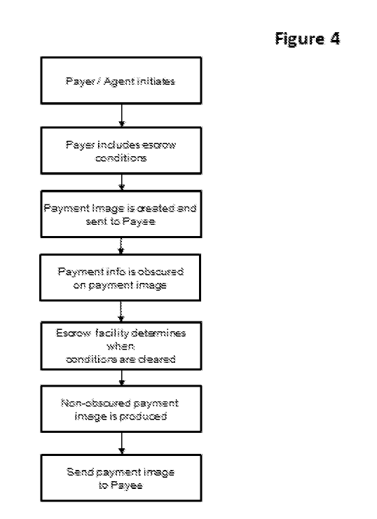

FIG. 4 shows a scenario where the payment image itself represents a “smart contract” and is held in escrow until certain conditions agreed to by the Payer and Payee are met. The escrow conditions can either be held in the Repository, or the payment image itself can be an executable that can inspect the digital world to determine if the escrow conditions have been satisfied or not. Until the escrow conditions are satisfied, some or all of the information in the payment image or watermark can be blurred or obscured to prevent someone from prematurely submitting and depositing the payment image.

Once the escrow conditions are satisfied, the payment image would be verified, and the obfuscated data elements within the image would be replaced with true and actual payment account and payment detail data elements. Or, if the escrow functionality is being performed by an executable payment image itself, upon recognizing the conclusion of the escrow conditions, the obscured payment image would redraw itself with one where all the data elements are fully intact and readable.

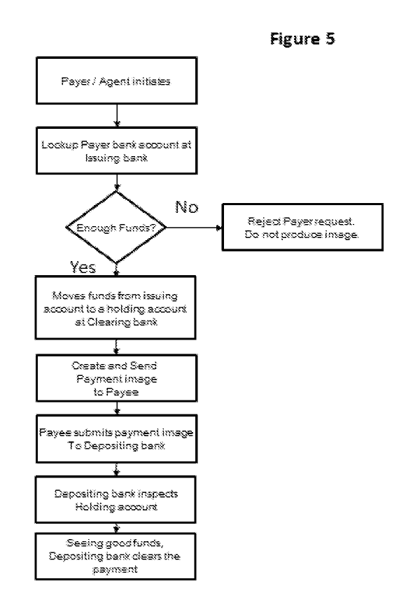

FIG. 5 illustrates a scenario where the funds for payment clearing are verified and held at initiation time. That is, at the time that the payment is initiated, the funds are verified at the issuing financial institution either by direct integration with the bank's core systems or through third-party account access aggregators. With “good funds” in the account to satisfy the new payment instructions, those funds can be either left in that named account and the payment image issued against that Payer's account, or a temporary subaccount can be created for the purposes of “locking away” those funds until the payment image is redeemed.

If a temporary subaccount is created, that account would have a separate and distinct account number from the Payer's named account, and it is the account number of that sub-account that will be referenced within the payment image. Once the payment is cleared and settled, the balance of that account would drop to zero and the account could automatically be closed.

The creation of individual payment-specific subaccounts would also provide traceability for which payment images have been redeemed and which are still outstanding. In this case, no additional tracking software is needed, and it is immediately evident which payments are outstanding when looking at the Payer's parent account.

Unlike certain current payment instruments, where there is no verification of good funds at payment inception and no way to guarantee for the Payee against a rejected transaction, by putting the safeguard of a good funds test and a funds hold at payment image creation, there is a guarantee against a bounced payment. This allows for a faster, less risky clearing and settlement process. Given this, a depositing institution could credit the Payee account immediately knowing that funds are guaranteed, instead of the typical 3-5 day clearing and funding period that is necessary with traditional paper checks, for example.

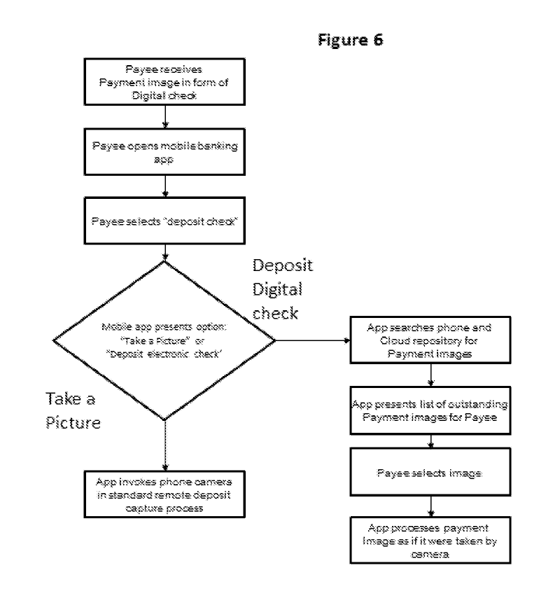

FIG. 6 illustrates a process for the acceptance of payment images by the Payee's bank through bank provided online, mobile, or other services. In this example, a mobile banking deposit scenario is shown. The key action in the typical remote deposit capture flow is the invocation of the camera on the mobile phone to take a picture of a paper check. Then that unstructured image needs to be processed, the relevant check details extracted and converted to a substitute check before clearing and settling.

In this situation, it is no longer necessary to invoke the phone camera. Because the payment image is an electronic file, it can be downloaded onto the Payee's mobile device, stored in the cloud, or streamed directly to the mobile banking app. Through a stand-alone mobile app or plugin, or an SDK that the mobile banking app integrates directly, the Payee is given the option of not invoking the camera, but instead selecting the appropriate payment image for deposit, either from those resident on the device or those at a location in the cloud accessible to the Payee.

Given the meta-data contained in the payment image, the mobile banking app could leverage the process shown in FIG. 2 to obtain the substitute check and bypass the need for traditional check image processing altogether.

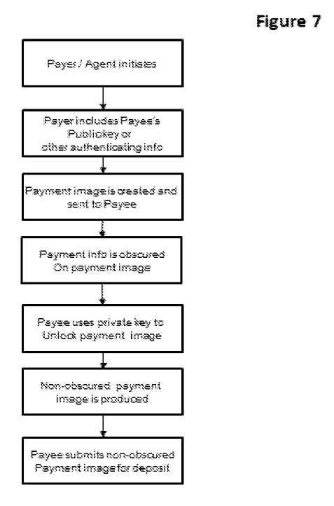

FIG. 7 shows a process for incorporating secret information into the payment image for the purposes of authentication and authorization. In the examples shown, this is the incorporation of the Payee's public key into the payment image, thereby requiring the Payee to present his private key in order to unlock the image and remove the obfuscation. Leveraging public key / private key technology, it's obvious to see the application of encryption to further safeguard the contents of the payment information, as an additional option.

Similar to the Escrow process shown in FIG. 4, the incorporation of authentication/authorization mechanisms may be done either at an external system or fully contained within an executable payment image. And, similarly, the sensitive payment information encapsulated within the payment image would be obscured until the authentication/authorization criteria are satisfied.

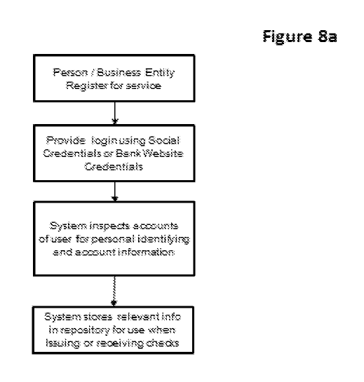

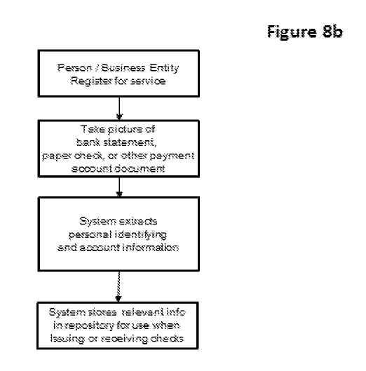

FIG. 8a illustrates a simple process for building and populating Repository information from publicly available data sources, and from sites and networks to which the individual provides authorized access. The Repository is used to store person or business entity information for the streamlined generation of payment images in the future, for the delivery preferences of the payee, and for security and payment history information, among other relevant information.

For instance, a user chooses to “login using my bank account” thereby utilizing the payment image system, but providing login credentials for his online bank account. From that bank account, the system gathers name, address, bank account, routing number, wire instructions, and other information. Then during payment image generation, this information is then retrieved from the Repository in order to prepopulate the payment information encapsulated within the payment image.

The user could also provide an electronic signature to the Repository, which could be utilized in various scenarios as authentication, authorization, and validation of the payment information in the payment information. Such information would be necessary depending on the payment settlement mechanism that is employed in order to clear and settle the payment.

Additionally, one could extend the system to store biometric information in the Repository as well, to use as an authentication/authorization mechanism of the payment.

Repository information could also be captured from Social Networking sites, email accounts, or any other electronic account. Any system that the user grants access to could serve as a source of information to populate the Repository.

FIG. 8b illustrates a process similar to FIG. 8a for extracting payment account information and populating the Repository. In this scenario, the information is gathered from paper documentation and extracted using techniques such as Optical Character Recognition. Such documents that would be useful for this include bank account statements, paper checks, and other documents that include information on the payment account.

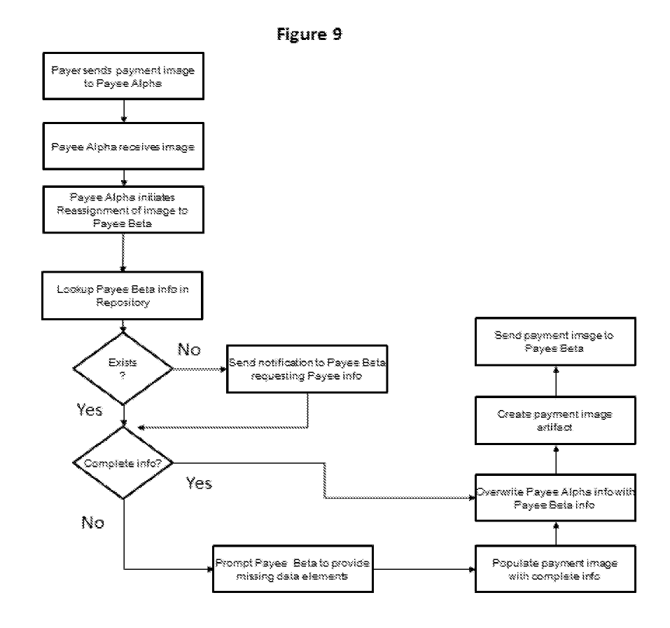

FIG. 9 illustrates a process for the dynamic assignment of Payee information on a payment image. Unlike with physical forms of payment such as written paper checks, because the payment image is in an electronic format, it can be manipulated and changed dynamically, so long as the designated Payee provides the appropriate authorization.

In this scenario, a first Payee, Payee Alpha, has received a payment image from a Payer. Instead of redeeming or depositing the payment image, however, the first Payee desires to transfer the payment to a new beneficiary, Payee Beta. This is akin to endorsing a paper check over to another person. However, in the case of a payment image, it is not necessary to endorse the back of the check. Instead, the payment information within the image is reassigned and Payee Alpha's information is replaced with Payee Beta's information.

This has a number of advantages over traditional payment forms, such as paper checks. First is that mobile remote deposit systems and some ATMs may not honor checks endorsed over to a new beneficiary. They may require that the Payee name on the check match the name on the account that the check is being deposited into. This approach of dynamic reassignment closes that gap and replaces the payee information with that of new beneficiary, and the redemption process for the payment image need not be aware of this transference of payee.

Another advantage is that this process can be repeated multiple times. Payee Alpha can reassign a payment image to Payee Beta, who can then turn around and reassign it to Payee Delta, and so on.

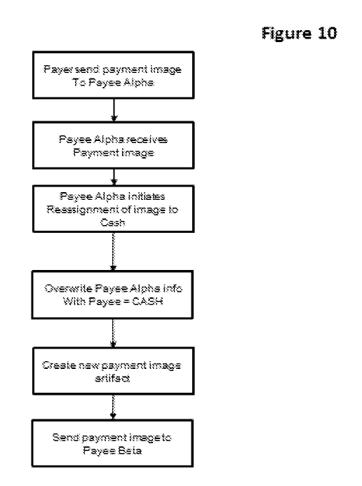

FIG. 10 illustrates a variation on the process of FIG. 9. In this scenario, instead of reassigning the payment image to a named new beneficiary, Payee Beta, the original payee, Payee Alpha, chooses to anonymize the payment. This is done by reassigning it to pay to CASH.

By assigning the payment image to CASH, the check then effectively becomes a bearer instrument that may be cashed, deposited, or held by anyone and not just a named beneficiary. This has the advantage of increasing the fungibility of the payment image.

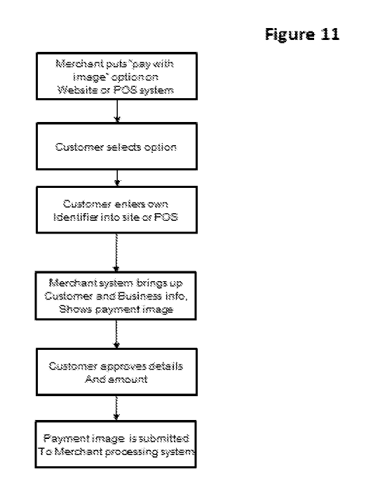

FIG. 11 shows a scenario where a payment image is used to make a purchase at either an online, mobile, or physical merchant. Through a plugin or integration with the ecommerce or point-of-sale software, the customer is presented with an option to pay with a payment image. In the scenario illustrated, the entire interaction is performed by the customer through the merchant POS terminal, but a variation is for the customer to initiate the payment through his own device and direct that to the merchant in a manner similar to that in FIG. 1.

In the scenario illustrated here, the customer engages only the merchant POS system. He enters his identifying credentials in order to authenticate. Then through the system and the repository, the payment image is prepopulated with the customer's payer information and, since the interaction is initiated from the merchant device, the system populates the Payee information from the merchant details stored in the Repository.

Once the payment image is issued, it can be submitted directly to the merchant's payment processing system and acceptance, clearing, and settlement can follow standard legacy payment processing or the process proposed here in FIG. 3.

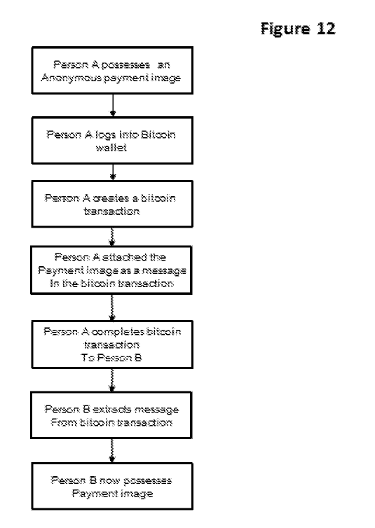

FIG. 12 illustrates a process for leveraging new emerging settlement protocols and cryptocurrencies and networks in order to facilitate the transfer and change of ownership of a payment image. This figure uses Bitcoin and the Bitcoin protocol as an example. But, similarly this could apply to other cryptocurrencies and emerging protocols that support for the transfer of digital currencies or digital assets. Examples of other such protocols include Ripple, Innotribe's Digital Asset Grid, Stellar, and other “altcoin” technologies.

In this scenario a person creates an anonymous payment through a process similar to that described in FIG. 10. Through the person's chosen bitcoin wallet, they create a transaction. The bitcoin protocol allows for the attachment of a “message” to the transaction. In this application, the payment image, is attached as this message. Then the person completes the transaction to another party. That other party inspects the transaction and retrieves the message. Given that the message is the payment image, the bitcoin transaction has just transferred the anonymous payment to the receiving party, who can submit it to his bank to deposit into his account. Or, the new owner can similarly send the payment image to another person over the bitcoin protocol.

It's important to note that the value of the Bitcoin transaction need not match the value associated with the payment image. The Bitcoin protocol, in this way, is simply the communication mechanism by which the payment image is transferred.

However, a variation would be to have the Bitcoin transaction be equal to the value of the payment image. In this way, the payment (i.e. Bitcoin plus payment image) is settled instantaneously with the transfer of the payment image. In such a scenario, Bitcoin is used as the settlement mechanism for the payment and the payment image is simply an artifact attached to the transaction in order to better document the transaction.

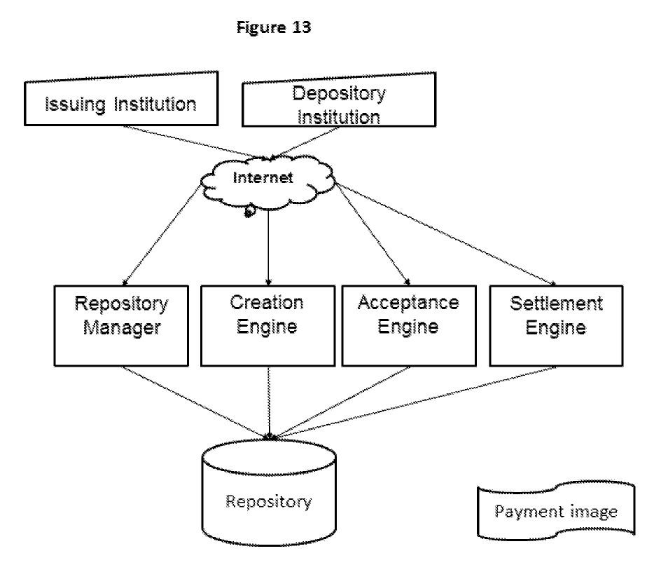

FIG. 13 illustrates key system components to implement the methods and processes herein described. A Repository is central to maintaining data about the Payer, Payee, and potentially even each payment image. A Repository Manager is responsible for populating the repository, leveraging information publicly available over the internet or from services and accounts that a person would grant access to. A Creation Engine leverages the data in the Repository and is the key component behind a request from a Payer to create a new payment image. An Acceptance Engine leverages the data in the Repository and extracts the data embedded in the payment image itself in order to streamline processing, clearing, and settlement. A Settlement Engine leverages the information contained in the payment image and works in concert with the systems at each financial institution in order to transfer funds in order to clear and settlement the instructions apropos of the payment details represented by the payment image.

The payment image itself can be either a simple data container and a visual image, or a self-executing embodiment of the processes described.

1. A computer-implemented method for effectuating a payment from one party to another through the use of images, comprising:
a. The electronic generation of an image representing payment instructions
b. Digital communications networks for the transmission of the payment image
c. The acceptance and processing of the payment image
d. Clearing and settlement of the payment through financial networks

2. A method for the generation, acceptance and processing of the payment images generated in claim 1 and conversion to a “substitute check” as described in the Check21 Act.

3. A method for embedding a “substitute check” and other relevant information as meta data or a watermark in the payment image of claim 1.

4. The method of claim 1 initiated by means of any electronic device (e.g., computer, tablet, phablet, mobile phone, smart device, etc.), whether initiated directly by a person or by an automated agent acting with or without instructions from a person.

5. A method for embedding conditions and triggers into the payment image representing business rules that must be satisfied before the payment image can be cleared.

6. A method for obfuscating certain details on the payment image to prevent fraudulent transactions and to prevent clearing before any conditions attached to the payment image are satisfied and resolved.

7. A method for securing the payment image to ensure proper delivery to the intended payee, through the use of encryption (e.g. public/private key), username/password, digital certificates, biometrics, secret questions and answers, or other authentication/authorization mechanisms.

8. A method for presenting the payment image as an electronic image that can be printed onto physical media, or maintained as an electronic and non-physical image, for consumption by an acceptance device or technology.

9. A method for payment image acceptance technologies to bypass the camera functionality and directly consume a stored or streamed payment image.

10. A method for integration with the computer system of the issuing financial institution in order to verify funds availability upon issuance of the payment image and for creating a hold on funds in order to ensure against rejection of the payment image during clearing.

11. A method for integration with the computer systems of the issuing and depositing financial institutions in order to provide real-time clearing and settlement of the payment image.

12. A method for the automated gathering and prepopulation of payment instructions on the payment image for either the payor or payee through the maintenance of a data repository. Payment instructions could include names of individuals or business entities, addresses, associated financial institution information, account and routing numbers, e-signatures, and other personal information.

13. A method for automated delivery of the payment image based on the information in the repository in claim 12 to the preferred location, either physical or electronic, of the payee.

14. A method for data gathering to populate portions of the repository in claim 12 through access to online banking, social networks, and other online accounts associated with the individual or business entity, or by scanning physical documents containing relevant information.

15. A method for associating the payment image with emerging financial settlement protocols (e.g. Bitcoin, Ripple, Stellar, Digital Asset Grid, etc.) for the transfer of the asset through those networks.

16. A method for utilizing emerging financial settlement protocols (e.g. Bitcoin, Ripple, Stellar, Digital Asset Grid, etc.) for the clearing and settlement of payment images.

17. A method for dynamically re-assigning the payee of the payment image at a time after the payment image is created.

18. A method for anonymizing the payment image in claim 17 and using as a transferrable bearer instrument.

19. A method for merchants to accept and process the payment image in order to effect payment for goods and services.

20. The payment image check in claim 1 and the processes detailed in claims 1-19 produced as a self-executing format.
